(19) United States
(12) Patent Application Publication
(10) Pub. No.: US 2006/0143415 A1
(43) Pub. Date: Jun. 29, 2006

(54) Managing shared memory access

(76) Inventor: Uday Naik, Fremont, CA (US)

Correspondence Address: FISH & RICHARDSON, PC, P.O. BOX 1022, MINNEAPOLIS, MN, 55440-1022, US

(21) Appl. No.: 11/026,337

(22) Filed: Dec. 29, 2004

(51) Int. Cl. G06F 12/14

(52) U.S. Cl. 711/163; 711/147

(57) ABSTRACT

Managing access to shared memory by a plurality of access entities includes storing a first identifier in a first storage location, the first identifier identifying a data structure in the shared memory; storing a second identifier in a second storage location associated with the first storage location, the second identifier identifying a first access entity; storing the second identifier for access by a second access entity; and signaling the first access entity by the second access entity, before the first access entity accesses the data structure.

### BACKGROUND

In a multi-processing computing environment, access to shared memory data structures is typically managed using a locking mechanism. Some processing architectures include a core processor and multiple on-board microengines each having multiple program counters to support multiple threads (or “contexts”). Instructions executing in threads from different microengines can potentially access the same address in a shared memory. A variety of mechanisms can be used to control access to the address including “strict thread ordering” in which threads access the address in a predetermined order, and “deli-ticket” locking in which a thread claims a number in a sequence and polls a status value to determine when its turn to access the address arrives.

### DESCRIPTION OF DRAWINGS

FIG. 1 is a block diagram of a system for managing access to a shared memory.

FIG. 2 is a flow chart for a process for accessing a shared memory.

FIG. 3A is a diagram of a linked list. FIG. 3B is a diagram of a CAM entry.

FIG. 4 is a block diagram of a network processor.

FIG. 5 is a block diagram of a processing engine.

FIG. 6 is a block diagram of a network device.

### DESCRIPTION

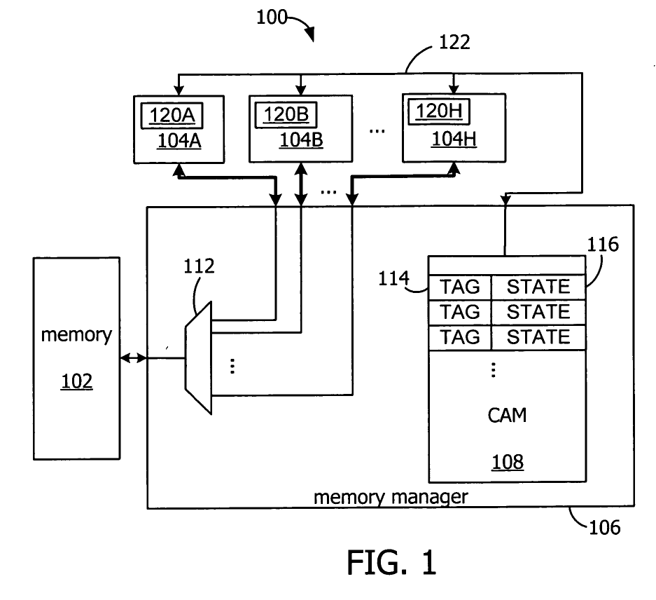

FIG. 1 shows a system 100 for managing access to a memory 102 (e.g., a static random access memory (SRAM)) shared by multiple access entities 104A-104H (e.g., execution threads of a multithreaded processor). Each access entity is identified by a unique access entity identifier (AEID). An access entity requests access to a data structure (not shown) in the memory 102 by providing a tag identifier (TID), such as a “flow ID” that identifies one of multiple packet flows. Alternatively, the TID can represent an address or block of addresses in the memory 102. Each TID uniquely identifies a corresponding data structure in the memory 102 that is to be sequentially accessed (e.g., accessed by not more than one access entity at a time).

An access entity can perform a variety of actions when accessing the data structure. For example, an access entity can read data from the data structure. An access entity can write data to the data structure. An access entity can read data, modify that data, and write the modified data back to the data structure.

The system 100 includes a memory manager 106 that manages a set of entries in a Content Addressable Memory (CAM) 108 to manage access to the shared data structures in the memory 102. In a Random Access Memory (RAM), an access entity supplies an address and the RAM returns the data stored at that address. In a CAM, an access entity supplies data and the CAM returns an indication of whether and/or where that data is stored in the CAM. For example, if the supplied data matches data stored in an a CAM entry (i.e., a CAM “hit”), the CAM returns the address of the matched entry. Otherwise, if the supplied data is not stored in a CAM entry (i.e., a CAM “miss”), the CAM returns a predetermined “miss value.”

The memory manager 106 provides access to the memory 102 based on TIDs stored in the CAM 108. The CAM 108 is used to protect a shared data structure or area in the memory 102 from being accessed by two or more access entities at the same time. If an access entity requests access to a shared data structure or shared area in memory 102, the access entity can “lock” the data structure or area by placing an entry in a CAM entry.

The CAM 108 determines whether a TID provided by an access entity matches a locked data structure TID stored in the CAM 108 and if so, returns to the address of the matched entry. The memory manager 106 also includes a bus arbiter 112 that provides an interface over which the access entities can read data from the memory 102 and write data to the memory 102.

Each CAM entry includes two associated storage locations. The first storage location is a tag field 114 for storing a TID and the second storage location is a state field 116 for storing an AEID. If two access entities request access to different data structures whose TIDs are not currently stored in the CAM 108, then the access entities store their respective TIDs in the CAM 108 and can access the respective data structures potentially concurrently. If an access entity provides a TID that is stored in the CAM 108, then that access entity adds itself to an access queue corresponding to that TID (e.g., using its AEID) and waits for its turn to access the data structure.

In one example, the access queue is implemented by a linked list that stores AEID values representing access entities in the access queue. The elements of the linked list are stored in registers 120A-120H (e.g., programmable Control/Status Registers) associated with the access entities 104A-104H, respectively. An access entity can start an access queue for a data structure that is not currently in use by setting the state field 116 of a new CAM entry to its own AEID. With only one access entity in the access queue, this state field value represents both the head and tail of the access queue. If another access entity wants to access the same data structure, then that access entity adds its AEID to the linked list in part by setting the register of the current tail, as described in more detail below, and represents the new tail of the access queue.

The access entities are in communication via communication bus 122 that enables one access entity to signal any other access entity that its turn to access the data structure has arrived. Each access entity can also set the register of any other access entity. The communication bus 122 is also used to communicate with the memory manager 106. The approach described herein enables the access entities to sequentially access the data structure without necessarily needing to repeatedly poll a flag or semaphore. For example, execution threads can swap out after joining the access queue and swap back in at the appropriate time to access the data structure without needing to waste cycles polling.

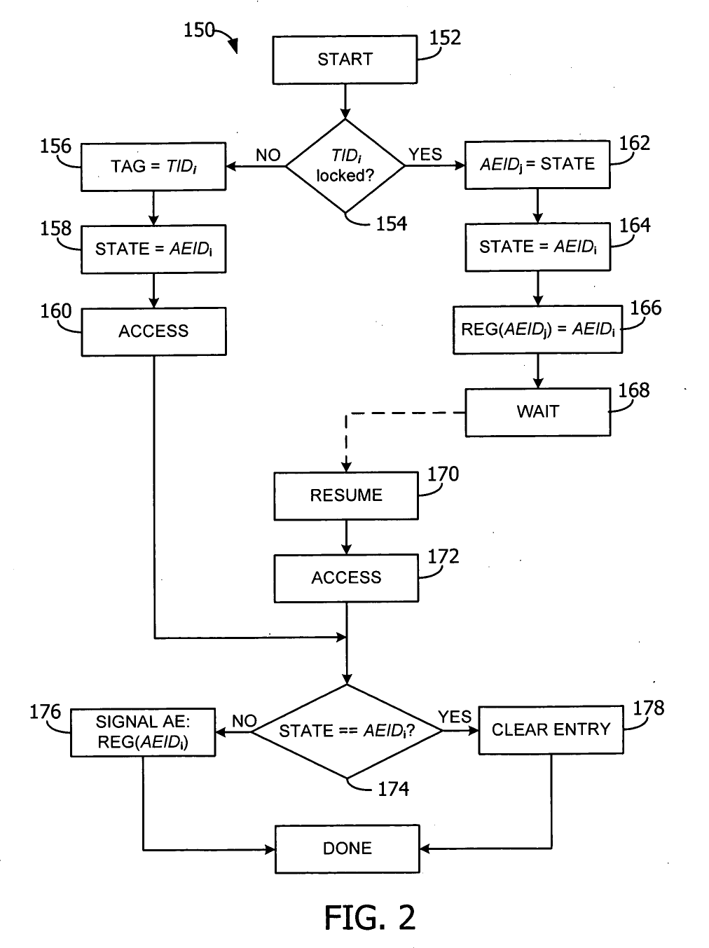

FIG. 2 shows an exemplary shared memory access process 150 that an access entity can use to access a shared data structure. An access entity with an identifier AEIDᵢ (“access entity AEIDᵢ”) starts 152 the process 150 by submitting a tag TIDᵢ to the CAM 108 to determine 154 whether the TIDᵢ data structure is currently locked.

The system 100 uses the tag field 114 and the state field 116 to determine whether a data structure is locked. If TIDᵢ is not in a tag field 114 (i.e., a CAM 108 “miss”), then the corresponding data structure is not locked. If TIDᵢ is in a tag field 114 (i.e., a CAM 108 “hit”) and the associated state field 116 is clear (e.g., having a null value), then the corresponding data structure is also not locked. If TIDᵢ is in a tag field 114 and the associated state field 118 is set (e.g., having an AEID value), then the corresponding data structure is locked.

If the TIDᵢ data structure is not locked, then access entity AEIDᵢ places a lock on the data structure before accessing it. Access entity AEIDᵢ places the lock by setting 156 the tag field 114 of an unused CAM entry to TIDᵢand setting 158 the associated state field 116 to its own AEID value AEIDᵢ. In some cases, there are enough CAM entries for all access entities to lock a different data structure (i.e., at least as many CAM entries as access entities). Any of a variety of techniques can be used to determine which CAM entry to use. For example, the entry whose state field 116 was least recently cleared can be used. After locking the data structure, access entity AEIDᵢ accesses 160 the data structure.

If the TIDᵢ data structure is locked, then access entity AEIDᵢ determines 162 the identifier AEIDⱼ of the tail of the access queue for the TIDᵢ data structure from the state field 116 of the matched CAM entry. Access entity AEIDᵢ adds itself to the access queue by overwriting 164 the state field 116 with its own AEID value AEIDᵢ and setting 166 the register of access entity AEIDⱼ to its own AEID value AEIDᵢ.

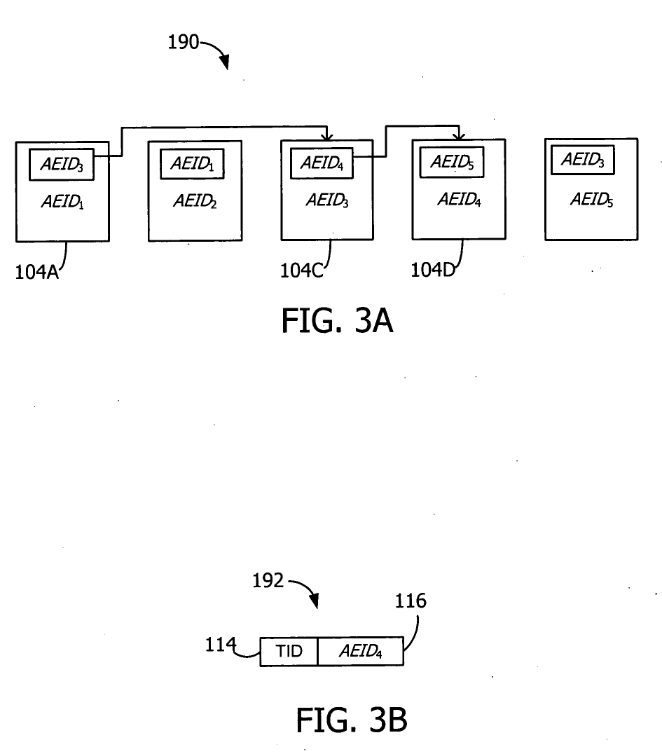

FIG. 3A shows an exemplary access queue implemented by a linked list 190 of register values.

FIG. 3B shows the associated CAM entry 192 for the data structure being accessed. The head of the access queue is access entity 104A identified as AEID₁. The register of access entity 104A has a value AEID₃ identifying access entity 104C. The register of access entity 104C has a value AEID₄ identifying access entity 104D. Access entity 104D is at the tail of the access queue (even though the register of access entity 104C has an AEID value) since the state field 116 of the CAM entry 192 has a value AEID₄ identifying access entity 104D as the tail.

Referring again to FIG. 2, after adding itself to the access queue, access entity AEIDᵢ goes into a waiting 168 state until its turn to access the data structure arrives. In this waiting state, access entity AEIDᵢ can become idle (e.g., an execution thread can swap out) or it can perform other actions that do not depend on accessing the data structure. At some point, the access entity AEIDᵢ is signaled by another access entity that its turn has arrived. After being signaled, access entity AEIDᵢ resumes 170 (e.g., an execution thread swaps in if necessary) and accesses 172 the data structure.

After accessing the data structure, access entity AEIDᵢ tests 174 the value of the state field 116 to determine whether it is equal to its own AEID value AEIDᵢ . If not, another access entity is at the tail of the access queue. In this case, access entity AEIDᵢ signals 176 the next access entity in the linked list as determined by the value of its own register. If the value of the state field 116 is equal to AEIDᵢ , then access entity AEIDᵢ clears 178 the CAM entry (e.g., by clearing the state field 116, or by clearing both the state field 116 and the tag field 114).

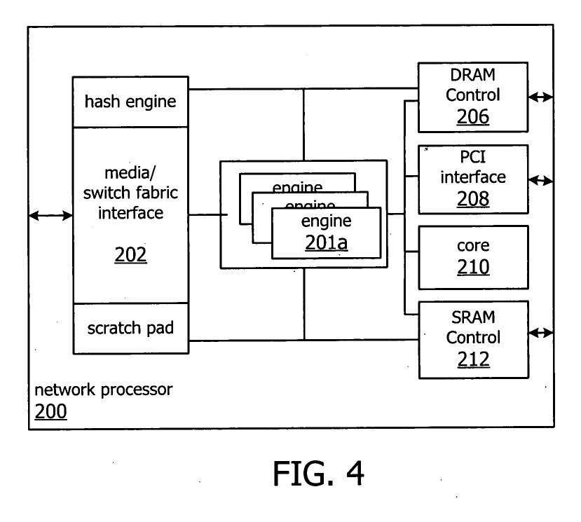

The techniques described above may be implemented in a variety of systems. For example, FIG. 4 depicts an example of network processor 200. The network processor 200 shown is an Intel® Internet exchange network Processor (IXP). Other network processors feature different designs.

The network processor 200 shown features a plurality of packet processing engines 201 on a single integrated semiconductor die. Individual engines 201 may provide multiple threads of execution. As shown, the processor 200 may also include a core processor 210 (e.g., a StrongARM® XScale®) that is often programmed to perform “control plane” tasks involved in network operations. The core processor 210, however, may also handle “data plane” tasks.

As shown, the network processor 200 also features at least one interface 202 that can carry packets between the processor 200 and other network components. For example, the processor 200 can feature a switch fabric interface 202 (e.g., a Common Switch Interface (CSIX)) that enables the processor 200 to transmit a packet to other processor(s) or circuitry connected to the fabric. The processor 200 can also feature an interface 202 (e.g., a System Packet Interface (SPI) interface) that enables the processor 200 to communicate with physical layer (PHY) and/or link layer devices (e.g., MAC or framer devices). The processor 200 also includes an interface 208 (e.g., a Peripheral Component Interconnect (PCI) bus interface) for communicating, for example, with a host or other network processors.

As shown, the processor 200 also includes other components shared by the engines 201 such as a hash engine, internal scratchpad memory shared by the engines, and memory controllers 206, 212 that provide access to external memory shared by the engines. Either or both of the controllers 206, 212 can include the memory manager 106 to provide the shared memory access techniques described herein. For example, the execution threads of the engines 201 can be the access entities.

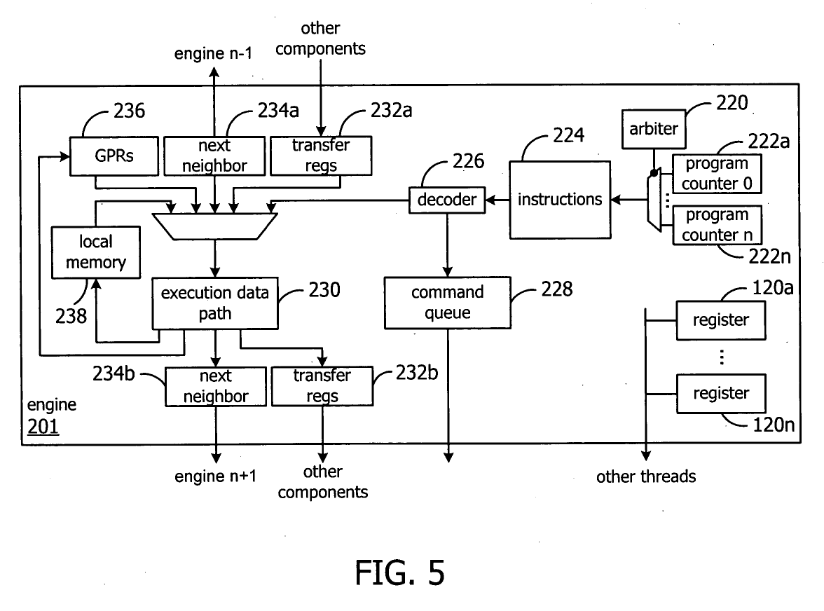

FIG. 5 illustrates a sample engine 201 architecture. The engine 201 may be a Reduced Instruction Set Computing (RISC) processor tailored for packet processing. For example, the engines 201 may not provide floating point or integer division instructions commonly provided by the instruction sets of general purpose processors.

The engine 201 may communicate with other network processor components (e.g., shared memory) via transfer registers 232a, 232b that buffer data to send to/received from the other components. The engine 201 may also communicate with other engines 201 via neighbor registers 234a, 234b wired to adjacent engine(s).

The sample engine 201 shown provides multiple threads of execution. Each thread has its own register 120 that can be set by any of the other threads. To support the multiple threads, the engine 201 stores program counters 222 for each thread. A thread arbiter 222 selects the program counter for a thread to execute. This program counter is fed to an instruction store 224 that outputs the instruction identified by the program counter to an instruction decode 226 unit. The instruction decode 226 unit may feed the instruction to an execution unit (e.g., an Arithmetic Logic Unit (ALU)) 230 for processing or may initiate a request to another network processor component (e.g., a memory controller) via command queue 228. The decoder 226 and execution unit 230 may implement an instruction processing pipeline. That is, an instruction may be output from the instruction store 224 in a first cycle, decoded 226 in the second, instruction operands loaded (e.g., from general purpose registers 236, next neighbor registers 234a, transfer registers 232a, and/or local memory 238) in the third, and executed by the execution data path 230 in the fourth. Finally, the results of the operation may be written (e.g., to general purpose registers 236, local memory 238, next neighbor registers 234b, or transfer registers 232b) in the fifth cycle. Many instructions may be in the pipeline at the same time. That is, while one is being decoded 226 another is being loaded from the instruction store 104. The engine 201 components may be clocked by a common clock input.

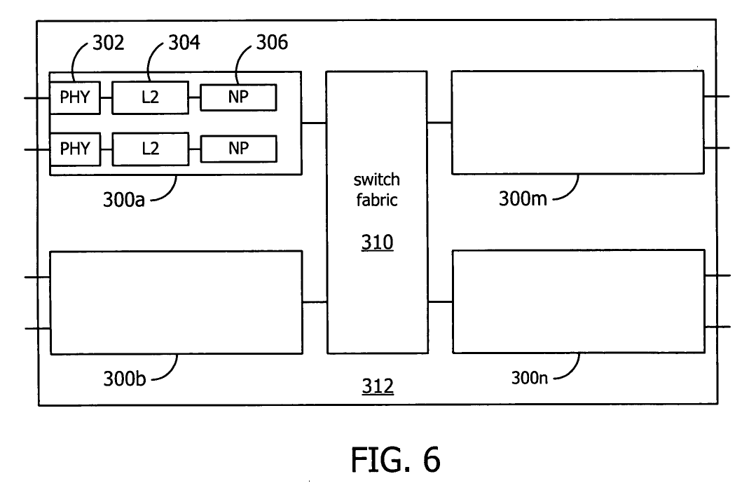

FIG. 6 depicts a network device 312 incorporating techniques described above. As shown, the device features a plurality of line cards 300 (“blades”) interconnected by a switch fabric 310 (e.g., a crossbar or shared memory switch fabric). The switch fabric, for example, may conform to CSIX or other fabric technologies such as HyperTransport, Infiniband, PCI, Packet-Over-SONET, RapidIO, and/or UTOPIA (Universal Test and Operations PHY Interface for ATM).

Individual line cards (e.g., 300a) may include one or more physical layer (PHY) devices 302 (e.g., optic, wire, and wireless PHYs) that handle communication over network connections. The PHYs translate between the physical signals carried by different network mediums and the bits (e.g., “0”-s and “1”-s) used by digital systems. The line cards 300 may also include framer devices (e.g., Ethernet, Synchronous Optic Network (SONET), High-Level Data Link (HDLC) framers or other “layer 2” devices) 304 that can perform operations on frames such as error detection and/or correction. The line cards 300 shown may also include one or more network processors 306 that perform packet processing operations for packets received via the PHY(s) 302 and direct the packets, via the switch fabric 310, to a line card providing an egress interface to forward the packet. Potentially, the network processor(s) 306 may perform “layer 2” duties instead of the framer devices 304.

While FIGS. 4-6 described specific examples of a network processor, engine, and a device incorporating network processors, the techniques may be implemented in a variety of hardware, firmware, and/or software architectures including network processors, engines, and network devices having designs other than those shown. Additionally, the techniques may be used in a wide variety of network devices (e.g., a router, switch, bridge, hub, traffic generator, and so forth).

The term packet was sometimes used in the above description to refer to a frame. However, the term packet also refers to a TCP segment, fragment, Asynchronous Transfer Mode (ATM) cell, and so forth, depending on the network technology being used.

The term circuitry as used herein includes hardwired circuitry, digital circuitry, analog circuitry, programmable circuitry, and so forth. The programmable circuitry may operate on computer programs. Such computer programs may be coded in a high level procedural or object oriented programming language. However, the program(s) can be implemented in assembly or machine language if desired. The language may be compiled or interpreted. Additionally, these techniques may be used in a wide variety of networking environments.

Other embodiments are within the scope of the following claims.

What is claimed is:

1. A method for managing access to shared memory by a plurality of access entities, comprising:
storing a first identifier in a first storage location, the first identifier identifying a data structure in the shared memory;
storing a second identifier in a second storage location associated with the first storage location, the second identifier identifying a first access entity;
storing the second identifier for access by a second access entity; and
signaling the first access entity by the second access entity, before the first access entity accesses the data structure.

2. The method of claim 1, wherein the second access entity signals the first access entity based on the second identifier.

3. The method of claim 1, wherein storing the second identifier for access by the second access entity comprises storing the second identifier in a register associated with the second access entity.

4. The method of claim 1, wherein the first and second storage locations comprise an entry in a content addressable memory.

5. The method of claim 1, further comprising:
storing a third identifier in the second storage location, the third identifier identifying the second access entity;
wherein the second identifier overwrites the third identifier in the second storage location.

6. The method of claim 1, wherein the access entities comprise processor execution threads.

7. The method of claim 1, wherein the data structure comprises a packet flow.

8. A method for managing access to shared memory by a plurality of access entities, comprising:
storing a linked list of values identifying access entities waiting to access a data structure in the shared memory; and
signaling one of the access entities from a first access entity at the head of the linked list after the first access entity is finished accessing the data structure.

9. The method of claim 8, wherein the access entities comprise processor execution threads.

10. The method of claim 8, wherein the data structure comprises a packet flow.

11. A processor comprising:
a plurality of processing engines integrated within a single chip, each processing engine having at least one execution thread; and
circuitry configured to
store a first identifier in a first storage location, the first identifier identifying a data structure in a shared memory;
store a second identifier in a second storage location associated with the first storage location, the second identifier identifying a first execution thread;
store the second identifier for access by a second execution thread; and
signal the first execution thread by the second execution thread, before the first execution thread accesses the data structure.

12. The processor of claim 11, wherein the data structure comprises a packet flow.

13. A processor comprising:
a plurality of processing engines integrated within a single chip, each processing engine having at least one execution thread; and
circuitry configured to
store a linked list of values identifying execution threads waiting to access a data structure in a shared memory; and
signal one of the execution threads from a first execution thread at the head of the linked list after the first execution thread is finished accessing the data structure.

14. The processor of claim 13, wherein the data structure comprises a packet flow.

15. A computer program product tangibly embodied on a computer readable medium, for managing access to shared memory by a plurality of access entities, comprising instructions for causing a computer to:
store a first identifier in a first storage location, the first identifier identifying a data structure in the shared memory;
store a second identifier in a second storage location associated with the first storage location, the second identifier identifying a first access entity;
store the second identifier for access by a second access entity; and
signal the first access entity by the second access entity, before the first access entity accesses the data structure.

16. The computer program product of claim 15, wherein the access entities comprise processor execution threads.

17. The computer program product of claim 15, wherein the data structure comprises a packet flow.

18. A computer program product tangibly embodied on a computer readable medium, for managing access to shared memory by a plurality of access entities, comprising instructions for causing a computer to:
store a linked list of values identifying access entities waiting to access a data structure in the shared memory; and
signal one of the access entities from a first access entity at the head of the linked list after the first access entity is finished accessing the data structure.

19. The computer program product of claim 18, wherein the access entities comprise processor execution threads.

20. The computer program product of claim 18, wherein the data structure comprises a packet flow.

21. A system comprising:
a network device including a shared memory for storing data packets;
a processor in communication with the shared memory and configured to
store a first identifier in a first storage location, the first identifier identifying a data structure in the shared memory;
store a second identifier in a second storage location associated with the first storage location, the second identifier identifying a first access entity;
store the second identifier for access by a second access entity; and
signal the first access entity by the second access entity, before the first access entity accesses the data structure.

22. The system of claim 21, wherein the access entities comprise processor execution threads.

23. The system of claim 21, wherein the data structure comprises a packet flow.

24. A system comprising:
a network device including a shared memory for storing data packets;
a processor in communication with the shared memory and configured to
store a linked list of values identifying access entities waiting to access a data structure in the shared memory; and
signal one of the access entities from a first access entity at the head of the linked list after the first access entity is finished accessing the data structure.

25. The system of claim 24, wherein the access entities comprise processor execution threads.

26. The system of claim 24, wherein the data structure comprises a packet flow.
